(19) United States
(12) Patent Application Publication
(10) Pub. No.: US 2025/0117555 A1
(43) Pub. Date: Apr. 10, 2025

(54) DIGITAL TWIN FEDERATION SYSTEM FOR INTEROPERABILITY AND FEDERATION BETWEEN DIGITAL TWINS AND OPERATING METHOD THEREOF

(71) Applicant: ELECTRONICS AND TELECOMMUNICATIONS RESEARCH INSTITUTE, Daejeon (KR)

(72) Inventors: Il Soon JANG, Daejeon (KR); Dae Ho KIM, Daejeon (KR); Chan Won PARK, Daejeon (KR); Soon Yong SONG, Daejeon (KR); Jin Chul CHOI, Daejeon (KR)

(21) Appl. No.: 18/906,300

(22) Filed: Oct. 4, 2024

(30) Foreign Application Priority Data
Oct. 6, 2023 (KR) 10-2023-0133577
May 3, 2024 (KR) 10-2024-0059476

(51) Int. Cl. G06F 30/27; G06F 111/02

(52) U.S. Cl. CPC G06F 30/27; G06F 2111/02

(57) ABSTRACT

A digital twin federation system for interoperability and federation between digital twins and an operating method thereof are provided. The digital twin federation system includes single digital twins to be federated, a metadata repository that stores metadata on the single digital twins and a federated digital twin, a federated digital twin generated by federating the single digital twins, and a management device that searches for a single digital twin providing a specific service among the single digital twins from the metadata repository through a search function to determine the single digital twin to be a digital twin for the federated digital twin, generates the federated digital twin where the single digital twins are federated, and generates a tool for providing a service of the federated digital twin, thereby expanding existing services and provide new services by federating digital twins, and easily solving problems involving domains through simulation and visualization.

### CROSS-REFERENCE TO RELATED APPLICATIONS

This application claims priority to and the benefit of Korean Patent Application No. 10-2023-0133577, filed on Oct. 6, 2023, and Korean Patent Application No. 10-2024-0059476, filed on May 3, 2024, which are hereby incorporated by reference for all purposes as if set forth herein.

### BACKGROUND

### 1. Field of the Invention

The present invention relates to a digital twin federation system for interoperability and federation between digital twins and operating method thereof to solve problems between different domains and perform new functions by interoperating or federating digital twins.

### 2. Description of Related Art

A digital twin is a technology that can allow for obtaining accurate information on the characteristics (current status, productivity, operation scenarios, etc.) of actual assets by creating a digital twin of a virtualized asset in software instead of an actual physical asset and conducting a simulation.

In various industries such as energy, aviation, healthcare, automobiles, and defense, the digital twin can be used to optimize assets, minimize the occurrence of unexpected accidents, and increase productivity. In this way, digital twins can improve the efficiency in all processes from design to manufacturing and service.

The field in which the digital twin is representatively utilized is cities. Virtual Singapore, which is a representative city digital twin, is a 3D model for the entire city-state of Singapore, and is being used for urban planning, traffic impact analysis, sunlight rights, emergency situation simulations, etc.

In addition to the urban field, the digital twin is being utilized in the manufacturing, energy, medical, and logistics fields.

These digital twins are being used in various fields, but since they are developed and used in different domains, simulations or visualizations thereof can be performed for problem solving in the relevant domains. However, these digital twins have many limitations in solving problems that occur due to entanglement between multiple complex and diversified domains.

### SUMMARY OF THE INVENTION

The present invention is directed to providing a digital twin federation system for interoperability and federation between digital twins and an operating method thereof for simulating and visualizing complex problems involving a plurality of domains to solve problems and providing new services by federating digital twins.

According to an aspect of the present invention, there is provided a digital twin federation system for interoperability and federation between digital twins including a plurality of single digital twins to be federated, a metadata repository that stores metadata on the plurality of single digital twins and a federated digital twin, a federated digital twin generated by federating the plurality of single digital twins, and a management device that searches for a single digital twin providing a specific service among the plurality of single digital twins from the metadata repository through a search function to determine the single digital twin to be a digital twin for the federated digital twin, generates the federated digital twin in which the plurality of single digital twins are federated, and generates a tool for providing a service of the federated digital twin.

The management device may generate the federated digital twin that provides a new service by federating the plurality of single digital twins based on a federated digital twin framework.

The management device may register and store information on at least one of data, modeling, a simulator, and a visualization module of the plurality of single digital twins in the metadata repository in a standardized manner, and include a search module that searches for data stored in the metadata repository.

The management device may include a bidirectional synchronization module that performs synchronization in time and space between data transmission and reception between the single digital twins and between data provided from the digital twins based on a federated twin framework.

The bidirectional synchronization module may perform a function of verifying validity and fidelity when the data transmitted from the digital twins has different data types and resolutions.

The management device may include a complex inference engine that generates a federated learning AI model suitable for a new service provided by the federated digital twin in cooperation with an AI model of the single digital twin based on a federated twin framework.

The management device may configure the federated digital twin by creating a hybrid simulation module that performs modeling and simulation techniques suitable for a new complex domain based on a federated twin framework.

The management device may further include a federated twin simulation authoring tool for combining heterogeneous single twin simulation models and a federated digital twin simulation model combiner for linked driving between discrete event or continuous time simulation models provided by the single digital twins.

According to another aspect of the present invention, there is provided an operating method of a digital twin federation system for interoperability and federation between digital twins, the method including registering, by a management device, metadata on a plurality of single digital twins to be federated in a metadata repository, searching for, by the management device, a single digital twin providing a specific service among the plurality of single digital twins from the metadata repository through a search function, determining, by the management device, a digital twin for a federated digital twin, and generating, by the management device, the federated digital twin by federating the plurality of digital twins.

In the generating of the federated digital twin, the management device may generate the federated digital twin that provides a new service by federating the plurality of single digital twins based on a federated digital twin framework.

In the generating of the federated digital twin, the management device may generate the federated digital twin that provides a service of the federated digital twin based on a federated twin simulation authoring tool for combining heterogeneous single twin simulation models and a federated digital twin simulation model combiner for linked driving between discrete event or continuous time simulation models provided by the single digital twin.

The registering of the metadata in the metadata repository may include standardizing, by the management device, information on data, modeling, a simulator, and a visualization module of the plurality of single digital twins.

In the searching for the digital twin, the management device may search for a single digital twin to constitute the federated digital twin from the metadata repository using a search module.

The operating method may further include performing, by the management device, synchronization in time and space between data transmission and reception between the single digital twins and between data provided from the digital twin through a bidirectional synchronization module based on a federated twin framework, after the determining of the digital twin.

The operating method may further include verifying, by the management device, validity and fidelity when the data transmitted from the digital twins has different data types and resolutions, after the determining of the digital twin.

The generating of the federated digital twin may further include generating, by the management device, a federated learning AI model suitable for a new service provided by the federated digital twin in cooperation with an AI model of the single digital twin based on the federated twin framework.

The generating of the federated digital twin may further include producing, by the management device, modeling and simulation suitable for a new complex domain based on the federated twin framework through a hybrid simulation module.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a federated digital twin system according to an embodiment of the present invention;

FIG. 2 is a diagram illustrating a detailed configuration of a federated digital twin according to one embodiment of the present invention;

FIG. 3 is a diagram illustrating a configuration in which a single digital twin, a metadata repository, and a synchronization server are connected to a federated digital twin according to an embodiment of the present invention;

FIG. 4 is a diagram illustrating a framework structure of the federated digital twin system according to an embodiment of the present invention;

FIG. 5 is a diagram illustrating a configuration for generating a federated digital twin of the framework structure of the federated digital twin system according to an embodiment of the present invention;

FIG. 6 is a diagram illustrating a configuration of a metadata repository of a federated digital twin system according to an embodiment of the present invention; and

FIG. 7 is a flowchart illustrating an operating method according to the creation of a federated digital twin of the federated digital twin system according to an embodiment of the present invention.

### DETAILED DESCRIPTION OF EXEMPLARY EMBODIMENTS

Hereinafter, an embodiment of a digital twin federated system for interoperability and federation between digital twins and an operating method thereof according to the present invention will be described. In this process, the thickness of the lines and the size of the components shown in the accompanying drawings may be exaggerated for the sake of clarity and convenience of description. In addition, the terms described below are terms defined in consideration of their functions in the present invention, and may vary depending on the intention or custom of the user or operator. Therefore, the definitions of these terms should be made based on the contents throughout this specification.

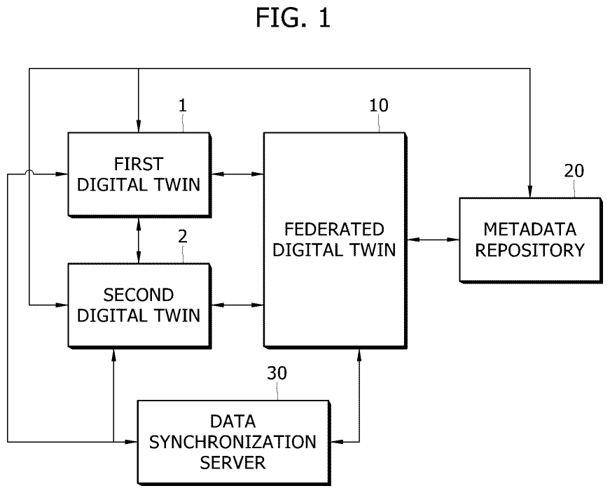

FIG. 1 is a diagram illustrating a federated digital twin system according to an embodiment of the present invention.

Referring to FIG. 1, the federated digital twin system according to an embodiment of the present invention may include a federated digital twin 10, a metadata repository 20, and a data synchronization server 30. In addition, the federated digital twin system may include a management device (not shown) that generates the federated digital twin 10.

In the present invention, it is described that operations are performed through a management device, a synchronization server, and a metadata repository included in a federated digital twin system, but each operation may also be performed by a higher-level federated digital twin system.

Each of single digital twins 1 and 2 is a digital twin to be federated and may perform a specific function.

The federated digital twin 10 is a digital twin that is generated by federation based on the single digital twins 1 and 2. The federated digital twin 10 may include not only the function of each of the single digital twins 1 and 2 to be federated, but may also include an additional function or new function through federation.

The management device may create the federated digital twin 10 by federating a plurality of single digital twins 1 and 2, and may create a tool for simulation and service operation of the federated digital twin 10. In some cases, the management device may be included in the federated digital twin 10.

The metadata repository 20 manages characteristic information of the digital twin. The metadata repository 20 may store and manage characteristic information of the federated digital twin 10 as well as characteristic information of the single digital twins 1 and 2.

The data synchronization server 30 performs data exchange between the metadata repository 20 and the digital twins 1, 2, and 10.

When different protocols are used when exchanging data between the digital twins or between the digital twin and the metadata repository 20, the data synchronization server 30 may convert the protocols.

In addition, the data synchronization server 30 may synchronize and convert data when exchanging data.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

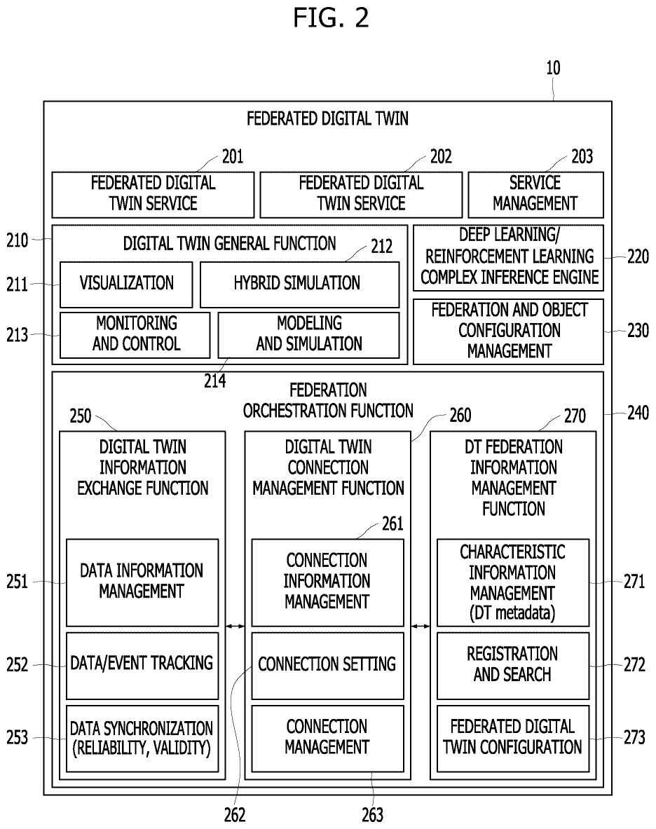

FIG. 2 is a diagram illustrating a detailed configuration of a federated digital twin according to an embodiment of the present invention.

As illustrated in FIG. 2, the federated digital twin 10 performs federated digital twin services 201 and 202 and a service management function 203 therefor.

The functions of the federated digital twin 10 may be executed by a plurality of modules for providing the services of the federated digital twin 10. The federated digital twin 10 may include a general function 210 of digital twins constituting the federation of digital twins, and may include an orchestration function 240 based on the federation of the single digital twins.

In addition, the federated digital twin 10 may include a deep learning and reinforcement learning complex inference engine module 220 and a federation and object configuration management function 230.

The general function 210 of the digital twin may include a visualization function 211, a hybrid simulation function 212, a monitoring and control function 213, and a modeling and simulation function 214.

The federation orchestration function 240 may include a digital twin information exchange function 250, a digital twin connection management function 260, and a digital twin (DT) federation information management function 270.

The digital twin information exchange function 250 is connected to a digital twin intended to be federated (a single digital twin) and provides a function of managing data provided by the single digital twins 1 and 2 and collecting and synchronizing data.

The digital twin information exchange function 250 may transmit a request for a specific service to the single digital twins 1 and 2 that constitute the federated digital twin 10.

The digital twin information exchange function 250 may include a data information management function 251, a data/event tracking function 252, and a data synchronization (reliability, validity) function 253.

The digital twin connection management function 260 provides a function of managing connection settings with a plurality of single digital twins that constitute the federated digital twin 10.

The digital twin connection management function 260 may include a connection information management function 261, a connection setting function 262, and a connection management function 263.

The digital twin federation information management function 270 may provide a function of managing characteristic information for the plurality of single digital twins 1 and 2 that constitute the federated digital twin 10, registering their characteristic information in a metadata repository or modifying the registered information, searching for digital twin characteristic information required for federation from the metadata repository, and managing configuration information by configuring a selected single digital twin as a digital twin that constitutes a federated digital twin.

The digital twin federation information management function 270 may include a characteristic information management function 271, a registration and search function 272, and a federated digital twin configuration function 273.

The federation orchestration function 240 may perform a new function that is not available in the single digital twin.

The federated digital twin 10 may exchange information of digital twins, manage connections between a plurality of single digital twins, configure the federation, and manage federation information through the federation orchestration function 240.

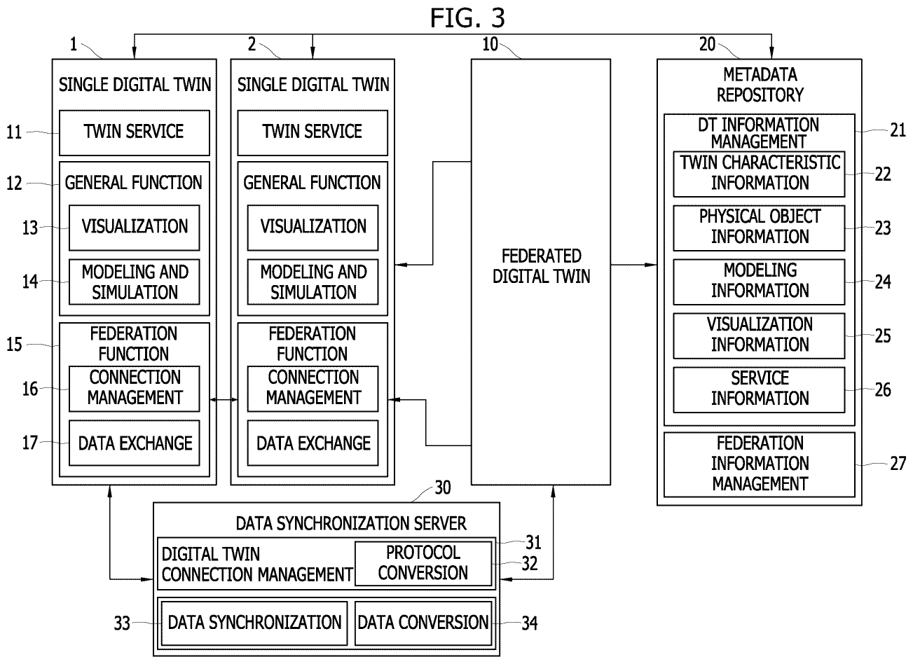

FIG. 3 is a diagram illustrating a configuration of a single digital twin, a metadata repository, and a synchronization server connected to a federated digital twin according to an embodiment of the present invention.

As illustrated in FIG. 3, the single digital twins 1 and 2 may include a twin service 11, a general function 12, and a federation function 15.

The twin service 11 relates to a service provided by the single digital twins 1 and 2.

The general function 12 relates to the function of the single digital twins 1 and 2, and may include a visualization function 13 and a modeling and simulation function 14.

Meanwhile, the federation function may be used when configuring a federated digital twin. The federation function 15 may include a connection management function 16 for managing a connection between single digital twins, and a data exchange function 17 for exchanging data between the single digital twins.

The metadata repository 20 stores the characteristic information of the single digital twins 1 and 2 that provide a digital twin federation function and the federated digital twin 10 to thereby provide digital twin search and characteristic information provision functions.

The metadata repository 20 may include a digital twin information management function 21 and a federation information management function 27.

The digital twin information management function 21 may include twin characteristic information 22, physical object information 23, modeling information 24, visualization information 25, and service information 26 for the single digital twins 1 and 2 or federated digital twin 10.

The federation information management functions 27 may manage federation information when federating a plurality of single digital twins.

Accordingly, a digital twin intended to be federated may search for desired digital twin characteristic information from the metadata repository 20 and obtain connection information. The digital twin may determine whether to be constituted into a federation based on the obtained connection information, and create a new federated digital twin, accordingly.

The data synchronization server 30 provides a function of converting a non-standard interface and data into a standard interface and data for data exchange with a digital twin that does not provide a standard interface and standard data model.

The data synchronization server 30 includes a connection management function 31 and a protocol conversion function 32 for the digital twin. In addition, the data synchronization server 30 may include a data synchronization function 33 and a data conversion function 34.

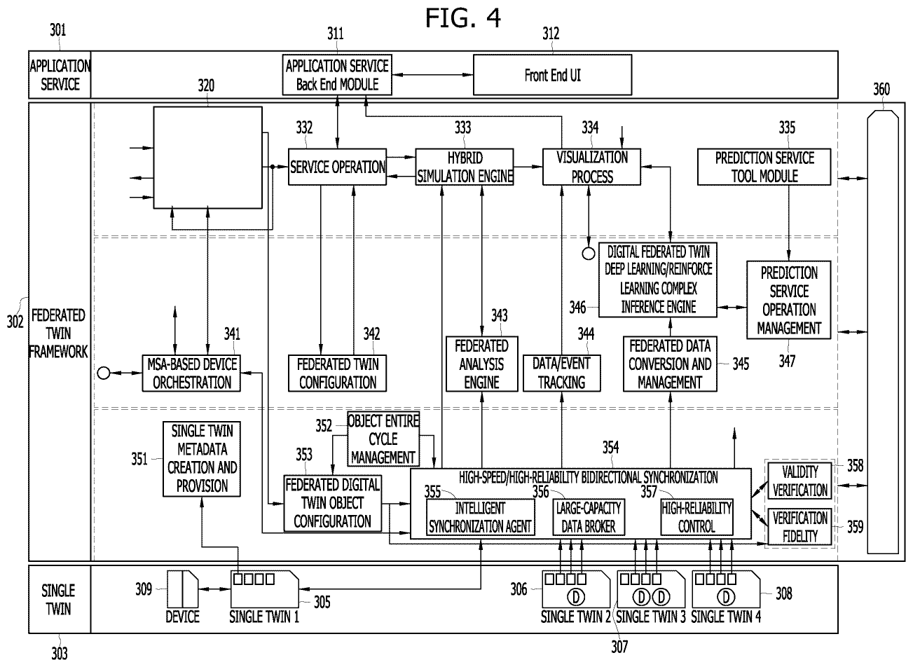

FIG. 4 is a diagram illustrating a framework structure of the federated digital twin system according to an embodiment of the present invention.

According to FIG. 4, the federated digital twin system may configure a federated digital twin framework by specifying the configuration of the federated digital twin 10 of FIG. 1.

The management device may create a federated digital twin that provides a new service by combining digital twins (single twin 303) that have been developed based on a federated digital twin framework.

The management device configures a federated digital twin framework 302 based on the single digital twin 303. The federated digital twin 10 may provide an application service 301 based on tools and engines provided through the management device.

The single digital twins 303 and 305 to 308 may be applied to a device 309 or provide the twin service 11 or the general function 12 to the federated digital twin 10.

The single digital twin 1 (305) may provide metadata to a single twin metadata creation and information provision module 351 of the federated digital twin framework 302.

Each of the single digital twins 2, 3, and 4 (306, 307, and 308) may provide modeling data, dynamic data, and static data to a high-speed/high-reliability bidirectional synchronization module (hereinafter, referred to as a bidirectional synchronization module) 354. In addition, the single digital twin 2, 3, and 4 (306, 307, and 308) may provide metadata to the single twin metadata creation and information provision module 351.

The federated digital twin framework 302 may configure a federated digital twin based on the metadata, modeling data, dynamic data, and static data of the single digital twin through a plurality of modules. Accordingly, the federated digital twin 10 may provide a new application service 301.

In a provision stage of the application service 301, an application service Back End module 311 may provide an application service to a front end user interface (UI) 312 based on a service operation module 332 and a visualization process (visualization module) 334. The federated digital twin framework 302 may include a federated digital twin object configuration module 353, a bidirectional synchronization module 354, a federated digital twin modeling analysis engine module (federated analysis engine module) 343, and a management module 320.

The federated digital twin 10 may receive and process data from at least one of a plurality of single twins 303 or the data synchronization server 30 by the management module 320 applying a signal to the bidirectional synchronization module 354.

The federated digital twin framework 302 registers the types of services and data that can be provided by the digital twins in the metadata repository 360 in order to utilize the types of services and data in a service and digital twin search process for performing the federation.

The metadata repository 360 may register or modify digital twin information according to a registration or modification request from the digital twins 305 to 308.

The federated digital twin framework 302 provides a search function (a digital twin search module 331) that may find a digital twin that satisfies specific conditions for digital twin characteristics, provided data, services, resource information, etc. in order to find a digital twin that supports the federated digital twin using the information stored in the metadata repository 360.

The federated digital twin framework 302 may determine a digital twin that constitutes (supports) the federated digital twin using the retrieved digital twin information (digital twin selection module 330).

The federated digital twin object configuration module 353 of the federated digital twin framework 302 manages information about the digital twin that supports the federated digital twin determined in this way, information about the service about the digital twin, and information about the federated digital twin.

The federated digital twin bidirectional synchronization module 354 of the federated digital twin framework 302 manages connection information for data transmission and reception between the federated digital twin and the digital twin. In this case the connection information includes a communication protocol, network address, data type, etc. for data transmission and reception between digital twins.

The federated digital twin bidirectional synchronization module 354 performs connection management between digital twins, and provides a connection management function of information for connection between digital twins that have already been retrieved and have supportable services and data for the federated digital twin or information for connection through a connection medium when one digital twin does not support the communication protocol used by the other digital twin between digital twins

The federated digital twin framework 302 may perform a function of exchanging data using a digital twin or a connection medium in order to perform the federation. The data exchange may be performed using the bidirectional synchronization module 354 provided by the federated digital twin framework 302.

The bidirectional synchronization module 354 supports communication protocol conversion between digital twins participating in data transmission and reception when direct data transmission between digital twins is impossible due to different communication protocols thereof. In addition, when formats of data used by digital twins are different from each other and the data cannot be interpreted after transmission and reception of data, the bidirectional synchronization module 354 converts the different data format into a data format that can be used by the digital twin that uses the data during a process of relaying and transmitting digital twin data and transmits the data.

The federated digital twin object configuration module 353 and the large-capacity bidirectional synchronization module 354 of the federated digital twin framework 302 performs a function of collecting and integrating data of the single digital twin provided through various interfaces and protocols, and synchronizing the data in the time and space desired by the federated digital twin service. The module 353 and module 354 perform a function of managing the transmission and reception of large-capacity data transmitted by each digital twin according to its characteristics, and reliably transmitting a control message transmitted by the service.

The intelligent digital federated twin modeling analysis engine module 343 of the federated digital twin framework 302 performs two functions of a federated simulation modeling technique and an analysis engine.

First, the federated simulation modeling technique may link various simulation models of discrete/continuous forms and synchronize data in time and space according to established rules.

Second, the federated twin modeling analysis engine module 343 may simulate and predict physical phenomena that may occur in a computational fluid dynamics-based physical analysis engine and the real world.

The federated digital twin 10 may include a hybrid simulation engine module 333, the visualization module 334, the 3D digital federated twin service presentation module (service operation module) 332, and a prediction service tool module 335 to thereby provide visualization functions for the application service, etc.

The hybrid simulation engine module 333 of the federated digital twin framework 302 performs a simulator function for driving an authoring tool capable of combining heterogeneous single twin simulation models and a federated simulation for the federated digital twin 10 generated through the federation between single digital twins.

The hybrid simulation engine module 333 may be executed and managed in the same time and space domain.

The visualization module 334 of the federated digital twin framework 302 performs a simulation post-processing function for visualizing and providing a pre-processing authoring module for configuring a physical analysis environment and simulation results.

The pre-processing authoring module performs the processing and combination functions of various 3D models for 3D physical analysis modeling and the function of inputting the material properties and external conditions of an object to be simulated.

The federated analysis engine module 343 provides a deep learning-based real-time physical analysis visualization function and a function to convert the results into user-recognizable information in order to drive the physical analysis model configured by the pre-processing module and obtain the results, thereby enabling developers to more easily implement various physical analysis techniques and easily provide them as runtime services.

The service operation module 332 for the three-dimensional federated digital twin 10 of the federated digital twin framework 302 performs various functions for visualizing large-capacity three-dimensional data in a web environment. The service operation module 332 performs a 3D lightweight/simplified function for smoothly displaying large-capacity 3D models on the web, and a function of supporting a 3D format as an input and converting the 3D format into a script-based standardized format.

The service operation module 332 pre-converts the same model into different levels of detail (LODs) such as low quality/medium quality/high quality, and performs a function capable of satisfying high visualization quality and smooth usability when implementing a federated digital twin web application service.

The prediction service tool module 335 of the federated digital twin framework 302 performs a prediction manager function that processes AI-based inference or prediction results for digital twins from users of the federated digital twin.

The prediction service tool module 335 performs an authoring function capable of training an AI prediction model using data collected from various digital twins.

A complex inference engine 346 may generate a federated learning AI model suitable for a new service provided by the federated digital twin in cooperation with the AI model of the single digital twin in the federated twin framework 302. The complex inference engine 346 may generate an AI model through deep learning or reinforcement learning for the federated digital twin.

The federated twin prediction service tool module 335 allows users to utilize GUI-based authoring functions to create an AI model with a pipeline structure or to modify and manage existing models, and the AI model generated through this authoring function can be loaded into the prediction manager to expand the AI-based analysis and prediction functions of the federated digital twin.

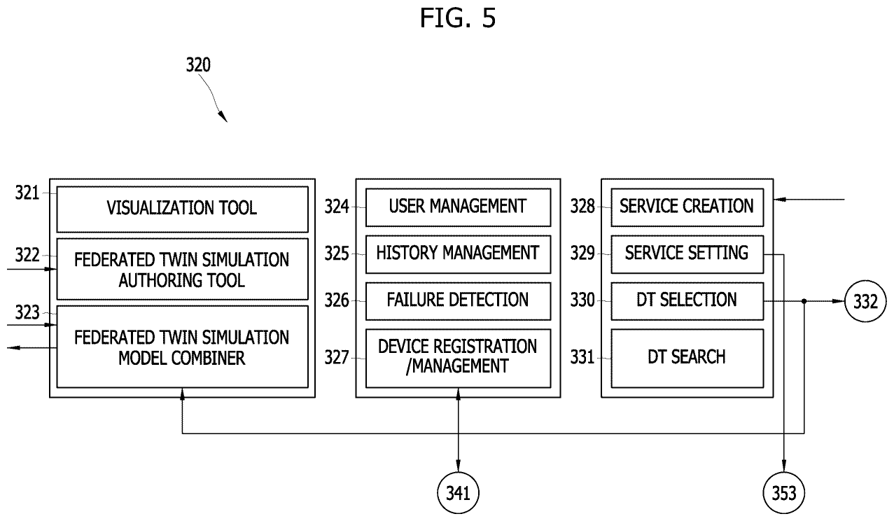

FIG. 5 is a diagram illustrating a configuration for generating a federated digital twin of a framework structure of a federated digital twin system according to an embodiment of the present invention.

According to FIG. 5, in the federated digital twin framework 302 of the management device, the management module 320 is set to include a visualization tool 321, a federated twin simulation authoring tool 322, and a federated twin simulation model combiner 323 to create processes, tools, and engines for the federated digital twin and to enable services to be performed through the processes and engines.

The management module 320 may perform functions according to a user manager 324 and history management 325.

In addition, the management module 320 may perform operations based on failure detection 326, device registration/management 327, service creation 328, service setting 329, a digital twin selection module 330, and a digital twin (DT) search module 331.

A MicroService Architecture (MSA)-based device orchestration module 341 may register and manage a device based on a database DB for devices, and process control for a single digital twin. In addition, the MSA-based device orchestration module 341 may request a service for control and the single twin.

The federated twin object configuration module 353 may set a service for the federated digital twin. The management module 320 may provide configuration information of the federated digital twin to the federated twin object configuration module 353 through the service setting 329.

The federated twin simulation model combiner 323 may select a digital twin that provides a service, and create a federated digital twin based on the selected digital twin.

The federated twin simulation model combiner 323 may be connected to the combined single digital twin 303 through a simulation model access API, and create the hybrid simulation engine module 333 for the federated digital twin 10. The hybrid simulation engine module 333 may execute and manage services in the same time and space domain.

The simulation authoring tool 322 may provide an authoring module that does not require coding in the form of a block diagram for linked driving between discrete event or continuous time simulation models provided by the single digital twins 303.

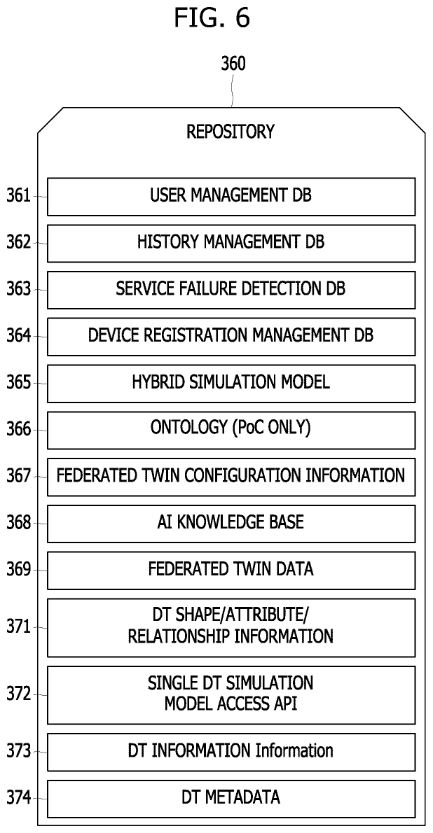

FIG. 6 is a diagram illustrating a configuration of a metadata repository of the federated digital twin system according to an embodiment of the present invention.

According to FIG. 6, a metadata repository 360 may include a user management DB 361, a history management DB 362, a service failure detection DB 363, a device registration management DB 364, a hybrid simulation model 365, an ontology (PoC ONLY) 366, federated twin configuration information 367, an AI knowledge base 368, and federated twin data 369.

In addition, the metadata repository 360 may include DT shape/attribute/relationship information 371, a single DT simulation model access API 372, DT information Information 373, and DT metadata 374.

The metadata repository 360 may store information on the types of services provided by the digital twin and data that can be provided therefrom in order to utilize the types of services and data in the service for performing the federation of the federated twin framework 302 and the digital twin search process thereof.

The metadata repository 360 may provide a function for storing and retrieving information on data, modeling, simulators, and visualization modules possessed by existing digital twins in the federated twin in a standardized manner.

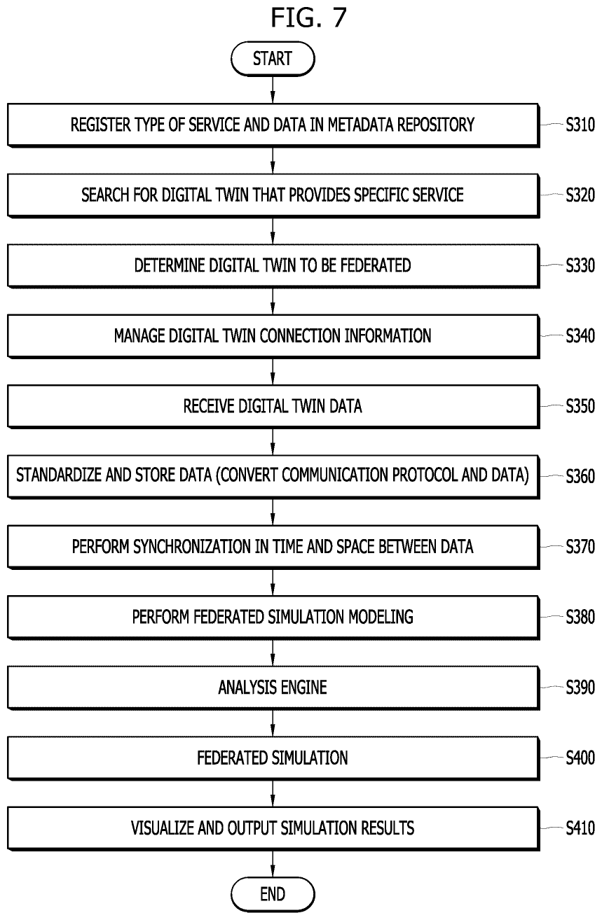

FIG. 7 is a flowchart illustrating an operating method according to the creation of a federated digital twin of a federated digital twin system according to an embodiment of the present invention.

According to FIG. 7, the management device of the federated digital twin system may provide services by creating a federated digital twin based on the federated digital twin framework through a processor and executing services according to the federated digital twin.

The management device registers the types of services that can be provided from a single digital twin and metadata on the digital twin in the metadata repository 360.

The management device may search for a digital twin that provides a specific service through the digital twin search module 331 (S320).

The management device determines the digital twin to be federated through the digital twin selection module 330 (S330) and manages connection information between the digital twins (S340).

The management device receives data of the digital twins (S350), and when the data is different or the protocol is different, the management device standardizes and stores the data (S360).

In this case, the management device may convert the communication protocol or convert the data through a federated data conversion and management module 345.

The management device performs synchronization in time and space between the data (S370) through the bidirectional synchronization module 354, and performs federated simulation modeling (S380).

The management device analyzes the modeled data through the federated analysis engine module 343 (S390) and performs simulation (S400).

The management device may visualize the simulation results through the visualization module 334 and output the simulation results through a front end UI (S410).

Therefore, a digital twin federation system for interoperability and federation between digital twins and operating method thereof according to the aspects of the present invention can expand existing services, provide new services, and easily solve problems involving a plurality of domains through simulation and visualization, by federating the digital twins.

The digital twin federation system for interoperability and federation between digital twins and the operating method thereof according to an aspect of the present invention can effectively perform modeling and simulation suitable for a new complex domain.

The digital twin federation system for interoperability and federation between digital twins and the operating method thereof according to an aspect of the present invention can expand service functions and effectively provide new services by searching for and federating digital twins that provide specific services.

The digital twin federation system for interoperability and federation between digital twins and the operating method thereof according to an aspect of the present invention can perform synchronization in time and space between provided data and perform a function of verifying validity and fidelity when the data transmitted from the digital twins has different data types and resolutions.

The digital twin federation system for interoperability and federation between digital twins and the operating method thereof according to an aspect of the present invention can effectively link a plurality of digital twins and easily solve problems involving a plurality of domains through simulation and visualization.

The present invention has been described with reference to embodiments illustrated in the drawings, but these are merely exemplary, and those skilled in the art will understand that various modifications and equivalent other embodiments are possible therefrom. Therefore, the technical protection scope of the present invention should be determined by the following patent claims.

What is claimed is:

1. A digital twin federation system for interoperability and federation between digital twins, comprising:
a plurality of single digital twins to be federated;
a metadata repository that stores metadata on the plurality of single digital twins and a federated digital twin;
a federated digital twin generated by federating the plurality of single digital twins; and
a management device that searches for a digital twin providing a specific service among the plurality of single digital twins from the metadata repository through a search function to determine the digital twin to be a digital twin for the federated digital twin, generates the federated digital twin in which the plurality of single digital twins are federated, and generates a tool for providing a service of the federated digital twin.

2. The digital twin federation system of claim 1, wherein the management device generates the federated digital twin that provides a new service by federating the plurality of single digital twins based on a federated digital twin framework.

3. The digital twin federation system of claim 1, wherein the management device registers and stores information on at least one of data, modeling, a simulator, and a visualization module of the plurality of single digital twins in the metadata repository in a standardized manner, and includes a search module that searches for data stored in the metadata repository.

4. The digital twin federation system of claim 1, wherein the management device includes a bidirectional synchronization module that performs synchronization in time and space between data transmission and reception between the single digital twins and between data provided from the digital twins based on a federated twin framework.

5. The digital twin federation system of claim 4, wherein the bidirectional synchronization module performs a function of verifying validity and fidelity when the data transmitted from the digital twins has different data types and resolutions.

6. The digital twin federation system of claim 1, wherein the management device includes a prediction service tool, and
the prediction service tool includes a complex inference engine that generates a federated learning AI model suitable for a new service provided by the federated digital twin in cooperation with an AI model of the single digital twin based on a federated twin framework.

7. The digital twin federation system of claim 1, wherein the management device configures the federated digital twin by creating a hybrid simulation module that performs modeling and simulation techniques suitable for a new complex domain based on a federated twin framework.

8. The digital twin federation system of claim 1, wherein the management device further includes:
a federated twin simulation authoring tool for combining heterogeneous single twin simulation models; and
a federated digital twin simulation model combiner for linked driving between discrete event or continuous time simulation models provided by the single digital twins.

9. An operating method of a digital twin federation system for interoperability and federation between digital twins, comprising:
registering, by a management device, metadata on a plurality of single digital twins to be federated in a metadata repository;
searching for, by the management device, a single digital twin providing a specific service among the plurality of single digital twins from the metadata repository through a search function;
determining, by the management device, a digital twin for a federated digital twin; and
generating, by the management device, the federated digital twin by federating the plurality of digital twins.

10. The operating method of claim 9, wherein, in the generating of the federated digital twin, the management device generates the federated digital twin that provides a new service by federating the plurality of single digital twins based on a federated digital twin framework.

11. The operating method of claim 9, wherein, in the generating of the federated digital twin, the management device generates the federated digital twin that provides a service of the federated digital twin based on a federated twin simulation authoring tool for combining heterogeneous single twin simulation models and a federated digital twin simulation model combiner for linked driving between discrete event or continuous time simulation models provided by the single digital twin.

12. The operating method of claim 9, wherein the registering of the metadata in the metadata repository includes standardizing, by the management device, information on data, modeling, a simulator, and a visualization module of the plurality of single digital twins.

13. The operating method of claim 9, wherein, in the searching for the digital twin, the management device searches for a single digital twin to constitute the federated digital twin from the metadata repository using a search module.

14. The operating method of claim 9, further comprising, after the determining of the digital twin, performing, by the management device, synchronization in time and space between data transmission and reception between the single digital twins and between data provided from the digital twin through a bidirectional synchronization module based on a federated twin framework.

15. The operating method of claim 14, further comprising, after the determining of the digital twin, verifying, by the management device, validity and fidelity when the data transmitted from the digital twins has different data types and resolutions.

16. The operating method of claim 9, wherein the generating of the federated digital twin further includes generating, by the management device, a federated learning AI model suitable for a new service provided by the federated digital twin in cooperation with an AI model of the single digital twin based on a federated twin framework.

17. The operating method of claim 9, wherein the generating of the federated digital twin further includes producing, by the management device, modeling and simulation suitable for a new complex domain based on a federated twin framework through a hybrid simulation module.
